(19) United States
(12) Patent Application Publication
(10) Pub. No.: US 2011/0122086 A1
(43) Pub. Date: May 26, 2011

(54) TOUCH DISPLAY MODULE AND TOUCH DISPLAY APPARATUS COMPRISING THE SAME

(75) Inventors: Kai-Cheng CHUANG, Hsinchu City (TW); Tzu-Ming WANG, Hsinchu City (TW); Tien-Haw PENG, Hsinchu City (TW); Chia-Hao KUO, Hsinchu City (TW); Po-Wen HSIAO, Hsinchu City (TW); Gwo-Feng HWANG, Hsinchu City (TW); Yung-Sheng CHUANG, Hsinchu City (TW)

(73) Assignee: Prime View International Co., Ltd., Hsinchu (TW)

(21) Appl. No.: 12/762,567

(22) Filed: Apr. 19, 2010

(30) Foreign Application Priority Data
Nov. 20, 2009 (TW) 098139675

(51) Int. Cl. G06F 3/045

(52) U.S. Cl. 345/174

(57) ABSTRACT

A touch display apparatus comprising a controller and a touch display module, electrically connected to the controller, are provided. The touch display module comprises a display panel and a sensor assembly. The display panel includes a display surface and a connection surface opposite the display surface, and the sensor assembly is disposed on the connection surface and electrically connected to the controller. The sensor assembly comprises a first sensing layer and a second sensing layer, with a first sheet conducting layer and a second sheet conducting layer, respectively. When the display surface is touched, the first sheet conducting layer and the second sheet conducting layer are electrically connected to generate a touch signal. Thereby, the controller may detect a touch position according to the touch signal.

### PRIORITY

This application claims priority to Taiwan Patent Application No. 098139675 filed on Nov. 20, 2009, which is incorporated by reference herein in its entirety.

### FIELD

The present invention relates to a touch display module and a touch display apparatus comprising the same. More particularly, the present invention relates to a touch display apparatus with a sensor assembly disposed on the non-display surface of a display panel.

### BACKGROUND

With the rapid development of touch display technologies, touch display panel products have been widely applied in smart phones, personal digital assistants (PDAs), E-books, web pads, digital cameras, global positioning systems (GPSs) and other consumer electronic products or office electronic products because of its advantages, such as simple integration, low power consumption, light weight, portability and low costs. Nowadays, the application scope of the touch display panel products has extended gradually from commercial businesses to the general public.

In recent years, flat or flexible display panel products have also experienced a rapid development in terms of functionalities, among which E-books have become popular. Current trends include integrating touch interfaces into E-books to make them more functional.

In general, a touch layer may be integrated into a touch display panel by use of, mostly, a resistive touch scheme, an infrared touch scheme, an ultrasonic touch scheme or a surface capacitive touch scheme. During the fabrication of a conventional touch display panel, the touch sensing layer made of a transparent glass substrate is attached directly onto a display surface of the display panel so that the touch can be made by a user straightforwardly onto the touch sensing layer. However, the transparent glass substrate is known to be very expensive. In addition, the substrate material conventionally used to make the display panel must be transparent, which imposes a significant limitation on the flexibility of material selection for fabricating the touch display panel.

Additionally, instead of using an additional backlight module, the E-books currently available display an image by using ambient light that is reflected. In such a case, the integration of a touch sensing layer on the display panel will lead to a significant degradation in the visual luminance of the display panel, thereby resulting in visual fatigue for the user.

In view of this, efforts still have to be made in the art to provide a solution that can utilize ambient light projected onto a touch display panel to successfully display an image, while reducing manufacturing costs, improving flexibility in material selection and increasing the visual luminance of the touch display panel.

### SUMMARY

To address the aforesaid problems, an objective of the present invention is to provide a touch display module and a touch display apparatus comprising the touch display module, which can improve the luminance of the touch display apparatus without increasing the manufacturing cost.

To achieve the aforesaid objective, certain embodiments of the present invention provide a touch display module adapted for a touch display apparatus, wherein the touch display apparatus comprises a controller and a touch display module. The touch display module, which is electrically connected to the controller, comprises a display panel and a sensor assembly. The display panel has a display surface and a connection surface opposite the display surface. The sensor assembly, which is disposed on the connection surface and electrically connected to the controller, comprises a first sensing layer and a second sensing layer. The first sensing layer has a first sheet conducting layer disposed on a first working surface of the first sensing layer, and the second sensing layer with a second sheet conducting layer disposed on a second working surface of the second sensing layer, wherein the second working surface corresponds to the first working surface. When the display surface is touched, the first sheet conducting layer and the second sheet conducting layer are electrically connected to generate a touch signal, such that the controller detects a touch position according to the touch signal.

Certain embodiments of the present invention also provide a touch display apparatus. The touch display apparatus comprises a controller and the touch display module described above.

With the aforesaid arrangement, the touch display module of the touch display apparatus may be disposed on the connection surface opposite the display surface, thus eliminating the need of using a substrate made of a costly transparent material for the touch display apparatus. This improves the flexibility in the selection of the substrate material and prevents the masking of the display surface of the display panel by the sensor assembly, resulting in a remarkable increase in the visual luminance of the display panel. Thereby, the problems of the prior art are addressed by the present invention.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a schematic view of a touch display apparatus according to an example embodiment of the present invention;

FIG. 2 is a schematic view of a sensor assembly;

FIG. 3 is a partial schematic view illustrating the operation mechanism of a sensor assembly of a four-wire resistive touch display module architecture;

FIG. 4 is a schematic view of another aspect of the sensor assembly; and

FIG. 5 is a schematic view of yet another aspect of the sensor assembly.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the spirit and scope of the invention as defined by the appended claims.

### DETAILED DESCRIPTION

In the following description, a touch structure of the present invention will be explained with reference to embodiments thereof. It shall be appreciated that these embodiments are not intended to limit the present invention to any specific environment, applications or particular implementations described in these embodiments. Therefore, description of these embodiments is only for the purpose of illustration rather than limitation.

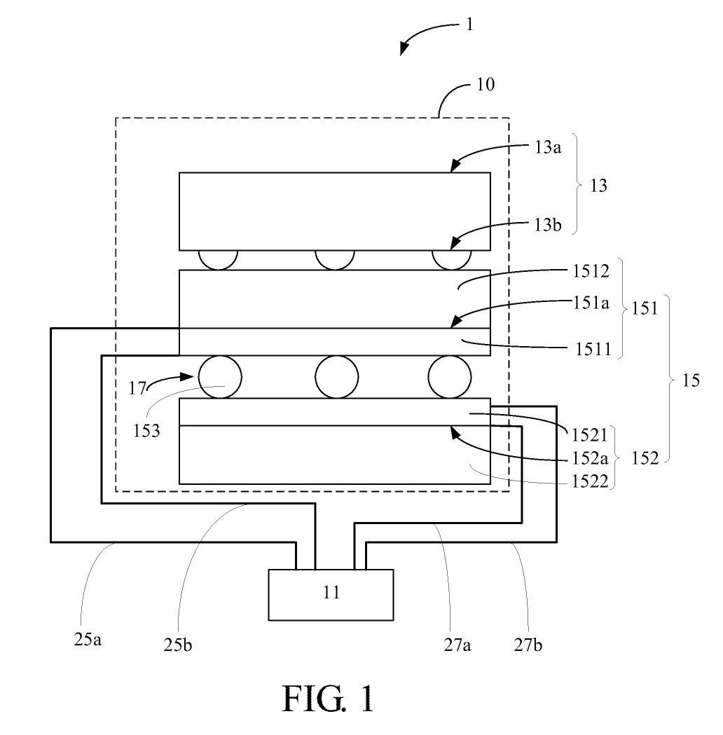

FIG. 1 illustrates a schematic view of a touch display apparatus 1 according to one example embodiment of the present invention. The touch display apparatus 1 comprises a touch display module 10 and a controller 11; in this example embodiment, the touch display module 10 is a four-wire resistive touch display module, although other aspects may also be devised by those skilled in the art based on the technical concepts of the present invention.

The touch display module 10 comprises a display panel 13 and a sensor assembly 15. The display panel 13 further has a display surface 13a and a connection surface 13b opposite the display surface 13a. In this example embodiment, an electrophoretic display (EPD) panel is preferably adopted for the display panel 13. The EPD panel has a plurality of microcapsules or microcups therein, each of which has at least a positively-charged white particle or at least a negatively-charged black particle. As a reflective display, the EPD panel can provide good sunlight readability; moreover, the EPD panel further has advantages, such as low power consumption and bi-stability. As a result, power is consumed only when changing images.

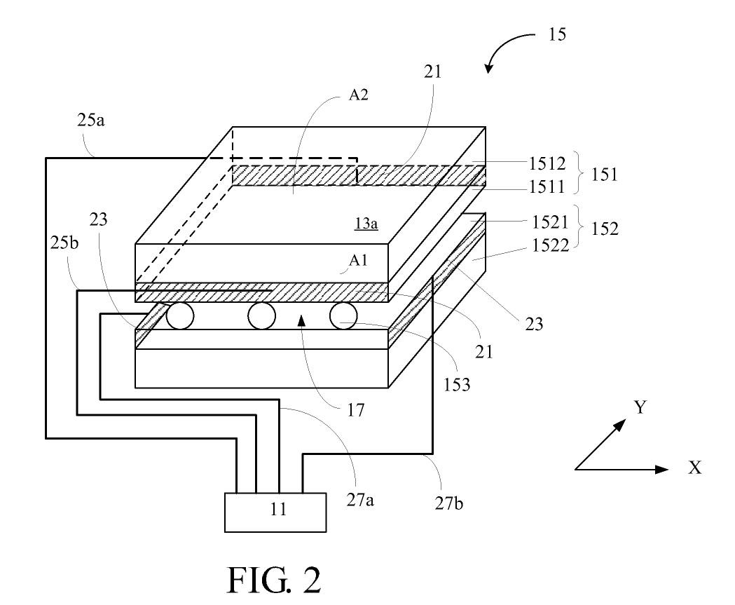

In addition, FIG. 2 illustrates schematic view of the sensor assembly 15. As shown in FIG. 1 and FIG. 2, the sensor assembly 15 is disposed on the connection surface 13b of the display panel 13, and electrically connected to the controller 11. The sensor assembly 15 comprises a first sensing layer 151, a second sensing layer 152, two first electrode wires 21, two second electrode wires 23, two first connection leads 25a, 25b, two second connection leads 27a, 27b and a plurality of spacers 153.

The first sensing layer 151 has, on the first working surface 151a thereof, a first sheet conducting layer 1511 and a first substrate 1512; on the other hand, the second sensing layer 152 has, on a second working surface 152a thereof, a second sheet conducting layer 1521 and a second substrate 1522. The second working surface 152a corresponds to the first working surface 151a, so the second sheet conducting layer 1521 and the first sheet conducting layer 1511 are disposed face to face. It shall be noted that in this embodiment, a first area A1 of the first sheet conducting layer 1511 is substantially equal to a second area A2 of the display surface 13a; however, in other aspects, the first area Al may be slightly smaller than the second area A2.

The two first electrode wires 21 are disposed respectively on two opposite sides of the first sheet conducting layer 1511 along a first direction, and the two second electrode wires 23 are disposed respectively on the two opposite sides of the second sheet conducting layer 1521 along a second direction. Specifically, the direction along which the two first electrode wires 21 are disposed and the direction along which the two second electrode wires 23 disposed are perpendicular to each other. In this embodiment, the first direction and the second direction are respectively in a Y-axis direction and a X-axis direction.

The two first connection leads 25a, 25b electrically connect each of the first electrode wires 21 to the controller 11 respectively, and the two second connection leads 27a, 27b electrically connect each of the second electrode wires 23 to the controller 11 respectively.

A plurality of spacers 153 are disposed between the first working surface 151a of the first sensing layer 151 and the second working surface 152a of the second sensing layer 152 to define a space 17 between the first sheet conducting layer 1511 and the second sheet conducting layer 1521. Therefore, the first sheet conducting layer 1511 and the second sheet conducting layer 1521 are electrically isolated from each other under normal conditions.

As the sensor assembly 15 of the present invention is disposed on the connection surface 13b of the display panel 13, an image to be displayed on the display panel 13 will not be masked due to the disposition of the sensor assembly 15. In other words, the sensor assembly 15 will not affect the display luminance of the display panel 13, so the selection of the material for the sensor assembly 15 becomes more flexible. That is, an opaque material may be adopted for the sensor assembly 15. In this embodiment, in terms of the materials selected for the individual components of the sensor assembly 15, the materials of the first sensing layer 151 and the second sensing layer 152 may comprise flexible substrate materials such as polyvinyl chloride, polyethylene terephthalate, polyimide, polyetheretherketone, polyethylene naphthalene-2,6-dicarboxylate, or a combination thereof; materials of the first sheet conducting layer 1511 and the second sheet conducting layer 1521 may comprise electrically conductive materials such as gold, copper, carbon, silver, tin and conductive polymer and the combination thereof. The aforesaid materials are only provided as an example in the embodiment, and the present invention is not merely limited thereto.

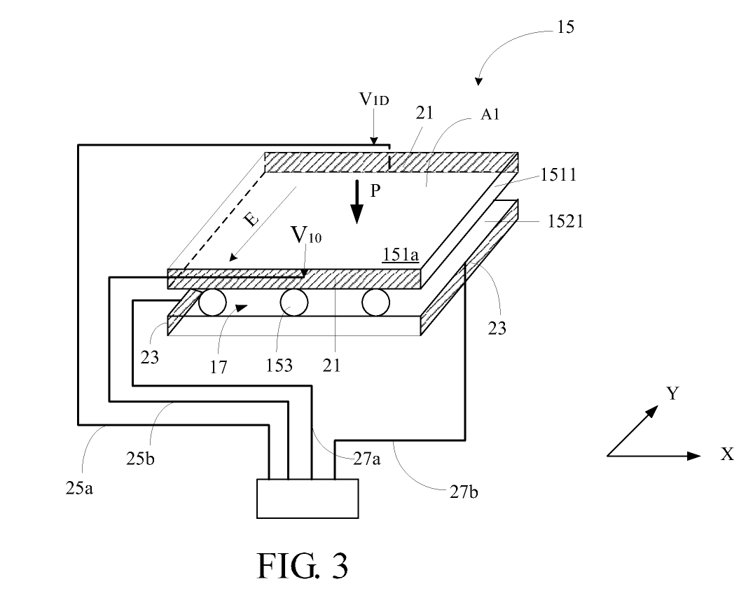

Next, the principle of detecting the touch position will be further illustrated with reference to the structure of the sensor assembly 15. FIG. 3 is a partial schematic view illustrating the operation mechanism of the sensor assembly 15 of the touch display module 10. The first substrate 1512 and the second substrate 1522 are omitted from depiction in FIG. 3 to more clearly show the working mechanism between the first sheet conducting layer 1511 and the second sheet conducting layer 1521. As shown in FIG. 3, the first electrode wires 21 have a first direct current voltage V_{1D} and a first ground voltage V₁₀ respectively, and by means of a potential difference therebetween, a uniform voltage field E is generated in the first sheet conducting layer 1511 along the Y-axis direction (the first direction). Similarly, the second electrode wires 23 have a second direct current voltage and a second ground voltage respectively, and by means of a potential difference therebetween, a uniform voltage field E is generated in the second sheet conducting layer 1521 along the X-axis direction (the second direction). This will not be further described herein.

Specifically, a touch on the display surface 13a may produce an appropriate pressure. Such a pressure forces the first sheet conducting layer 1511 and the second sheet conducting layer 1521, which are originally electrically isolated from each other, to make contact with each other at the touch position P to be electrically connected. At this moment, the controller will first turn on the first sheet conducting layer 1511 by providing the first direct current voltage V_{1D} and the first ground voltage V₁₀ to the first electrode wires 21 respectively, so that a uniform voltage field E is generated in the first sheet conducting layer 1511 along the Y-axis direction (the first direction) by means of a potential difference therebetween. The second sheet conducting layer 1521 then transmits a voltage, which was received when the first sheet conducting layer 1511 and the second sheet conducting layer 1521 made contact with each other at the touch position P, to the controller 11 for an analog-to-digital (A/D) signal conversion to generate a touch signal. By comparing the touch signal with the aforesaid uniform voltage field, a Y-axis coordinate value (a first direction coordinate value) of the touch position P may be obtained.

Similarly, after the Y-axis coordinate value (the first direction coordinate value) of the touch position P is obtained, the controller 11 then turns on the second sheet conducting layer 1521 by providing a second direct current voltage and a first ground voltage to the second electrode wires 23 respectively, so that a uniform voltage field is generated in the second sheet conducting layer 1521 along the X-axis direction (the second direction) by means of a potential difference therebetween. The first sheet conducting layer 1511 then transmits a voltage, which was received when the first sheet conducting layer 1511 and the second sheet conducting layer 1521 made contact with each other at the touch position P, to the controller 11 for an A/D signal conversion to generate a touch signal. By comparing the touch signal with the aforesaid uniform voltage field, an X-axis coordinate value (a second direction coordinate value) of the touch position P is obtained. Therefore, according to the touch signals of the touch position P, the X-axis coordinate value and the Y-axis coordinate value can be calculated sequentially by the controller 11, thereby accomplishing the detection of the touch position P.

It should be appreciated that although the sensor assembly 15 is described above with reference to only the four-wire resistive touch module architecture, the sensor assembly 15 of the present invention may also be optionally modified into the four-wire, five-wire, six-wire or eight-wire resistive touch module architecture, and no limitation is made thereon herein. For purposes of understanding, a brief description will be further made hereinafter.

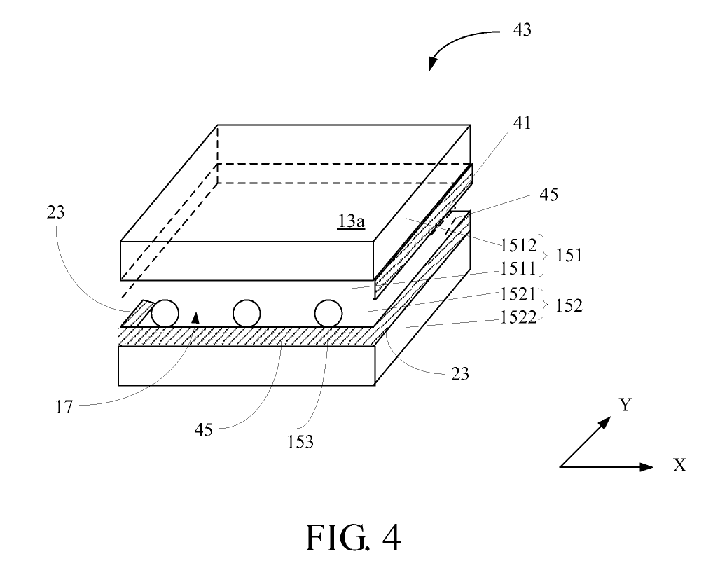

FIG. 4 shows another aspect of the sensor assembly 15 of FIG. 3. As shown in FIG. 4, the sensor assembly 43 is adapted for a five-wire resistive touch module and differs from the sensor assembly 15 only in that the two first electrode wires 45 are disposed respectively on two opposite sides of the second sheet conducting layer 1521 along the Y-axis direction (the first direction). In other words, the four edges of the second sheet conducting layer 1521 are all provided with electrode wires. Furthermore, although the periphery of the first sheet conducting layer 1511 has no electrode wire disposed thereon, a detection line 41 is further electrically connected therefrom.

Similarly, when the five-wire resistive touch module detects the touch position, the controller 11 will turn on the second sheet conducting layer 1521 but first provides the first direct current voltage V_{1D} and the first ground voltage V₁₀ to the first electrode wires 45 respectively. By means of the detection line 41 electrically connected to the first sheet conducting layer 1511, the voltage received when the first sheet conducting layer 1511 and the second sheet conducting layer 1521 come into contact with each other at the touch position P is obtained for processing by the controller 11 to obtain a Y-axis coordinate value (the first direction coordinate value) of the touch position P. Afterwards, the controller 11 provides the second direct current voltage and the second ground voltage to the second electrode wires 23 respectively and, also by means of the detection line 41 electrically connected to the first sheet conducting layer 1511, the voltage received when the first sheet conducting layer 1511 and the second sheet conducting layer 1521 come into contact with each other at the touch position P is obtained for processing by the controller 11 to obtain an X-axis coordinate value (the second direction coordinate value) of the touch position P. It should be appreciated that the elements and associated operation mechanism identical to what has been described above will not be further described herein.

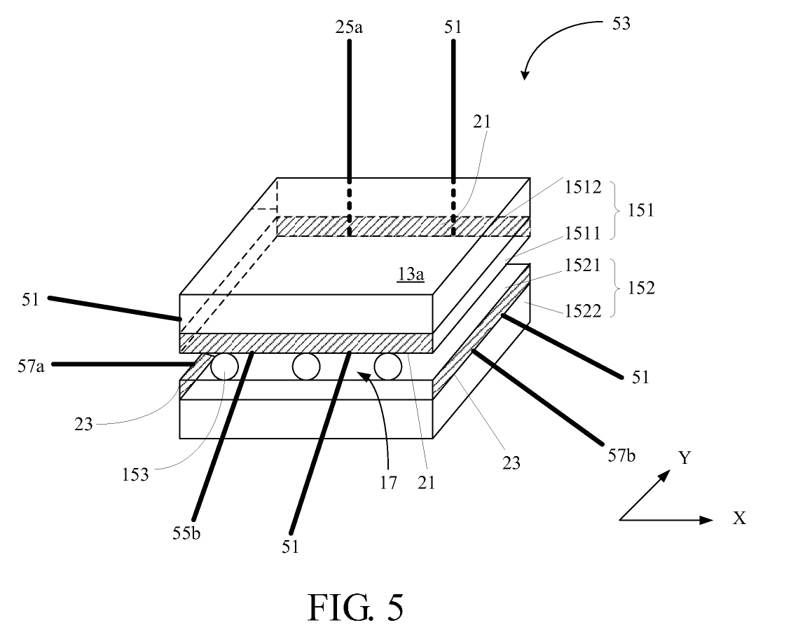

FIG. 5 illustrates another aspect of the sensor assembly 15 of FIG. 3. As shown in FIG. 5, the sensor assembly 53 is adapted for an eight-wire resistive touch module and differs from the sensor assembly 15 in that the sensor assembly 53 also has two first connection leads 55a, 55b and two second connection leads 57a, 57b. Furthermore, each of the first electrode wires 21 and the second electrode wires 23 is electrically connected to a reference wire 51 respectively. In other words, the four reference wires 51 are additionally disposed in the sensor assembly 15. The purpose of disposing the additional reference wires 51 is to enable the controller 11 to read the voltage values more exactly by means of the reference lines 51. It should be appreciated that the elements and associated operation mechanism identical to what has been described above will also not be further described herein.

In summary, with the aforesaid arrangement of the display panel and the sensor assembly, the sensor assembly is successfully integrated onto the reflective EPD panel while using natural light as a source of display light, thereby eliminating the need of a backlight module. Moreover, because the present invention makes it unnecessary to dispose the sensor assembly onto the display surface of the display panel, the flexibility in the selection of manufacturing materials is increased, thereby overcoming the drawback of conventional touch display panels in which the luminance of the display degrades as it is being masked by the sensor assembly. Thus, the problems of the prior art are solved effectively by the present invention. Through the aforesaid arrangement, a frame displayed on the display surface can be directly presented to the eyes of a user with a desirable display luminance without being masked by the sensor assembly.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A touch display module adapted for a touch display apparatus, the touch display apparatus comprising a controller, the touch display module, electrically connected to the controller, comprising:
a display panel having a display surface and a connection surface opposite to the display surface;
a sensor assembly disposed on the connection surface and electrically connected to the controller, the sensor assembly comprising:
a first sensing layer having a first sheet conducting layer disposed on a first working surface of the first sensing layer;
a second sensing layer having a second sheet conducting layer disposed on a second working surface of the second sensing layer, the second working surface corresponding to the first working surface;
two first electrode wires disposed respectively on two opposite sides of the first sheet conducting layer along a first direction;
two second electrode wires disposed respectively on two opposite sides of the second sheet conducting layer along a second direction, the first direction and the second direction being perpendicular to each other; and
a plurality of spacers disposed between the first sensing layer and the second sensing layer for electrically isolating the first sheet conducting layer and the second sheet conducting layer, a space defined between the first sheet conducting layer and the second sheet conducting layer;
wherein the first sheet conducting layer and the second sheet conducting layer are electrically connectable when pressed, thereby generating a touch signal, such that the controller detects a touch position according to the touch signal.

2. The touch display module of claim 1, wherein the first electrode wires have a first direct current voltage and a first ground voltage respectively, so that the first sheet conducting layer has a uniform voltage field therein along the first direction.

3. The touch display module of claim 2, wherein the controller provides the first direct current voltage and the first ground voltage to the first electrode wires, and thereby the controller receives the touch signal coming from the second sheet conducting layer to determine a first direction coordinate value of the touch position.

4. The touch display module of claim 3, wherein the controller provides the second direct current voltage and the second ground voltage to the second electrode wires, and thereby the controller receives the touch signal coming from the first sheet conducting layer to determine a second direction coordinate value of the touch position.

5. The touch display module of claim 1, wherein the second electrode wires have a second direct current voltage and a second ground voltage respectively, so that the second sheet conducting layer has a uniform voltage field therein along the second direction.

6. The touch display module of claim 1, wherein the sensor assembly further comprises four reference lines.

7. The touch display module of claim 1, wherein a first area of the first sheet conducting layer is equal to or smaller than a second area of the display surface.

8. The touch display module of claim 1, wherein the display panel comprises an electrophoretic display (EPD) panel.

9. The touch display module of claim 8, wherein the EPD panel includes a plurality of microcapsules or microcups.

10. The touch display module of claim 9, wherein each of the microcapsules or microcups includes at least a positively-charged white particle or at least a negatively-charged black particle.

11. The touch display module of claim 1, wherein the first sensing layer and the second sensing layer include one or more materials selected from the group consisting of polyvinyl chloride, polyethylene terephthalate, polyimide, polyetheretherketone, polyethylene naphthalene-2, and 6-dicarboxylate.

12. The touch display module of claim 1, wherein the first sheet conducting layer and the second sheet conducting layer include one or more materials selected from the group consisting of gold, copper, carbon, silver, tin, and conductive polymer.

13. A touch display module adapted for a touch display apparatus, the touch display apparatus comprising a controller, the touch display module, electrically connected to the controller, comprising:
a display panel having a display surface and a connection surface opposite to the display surface;
a sensor assembly disposed on the connection surface and electrically connected to the controller, the sensor assembly comprising:
a first sensing layer having a first sheet conducting layer disposed on a first working surface of the first sensing layer;
a second sensing layer having a second sheet conducting layer disposed on a second working surface of the second sensing layer, the second working surface corresponding to the first working surface;
two first electrode wires disposed respectively on two opposite sides of the second sheet conducting layer along a first direction;
two second electrode wires disposed respectively on two opposite sides of the second sheet conducting layer along a second direction, the first direction and the second direction being perpendicular to each other; and
a plurality of spacers disposed between the first sensing layer and the second sensing layer for electrically isolating the first conducting layer and the second sheet conducting layer, a space defined between the first sheet conducting layer and the second sheet conducting layer;
wherein the first sheet conducting layer and the second sheet conducting layer are electrically connectable while being pressed to generate a touch signal, and the controller detects a touch position according to the touch signal.

14. The touch display module of claim 13, wherein the sensor assembly further comprises a detection line electrically connected to the first sheet conducting layer.

15. The touch display module of claim 13, wherein a first area of the first sheet conducting layer is equal to or smaller than a second area of the display surface.

16. The touch display module of claim 13, wherein the display panel comprises an electrophoretic display (EPD) panel.

17. The touch display module of claim 16, wherein the EPD panel comprises a plurality of microcapsules or microcups.

18. The touch display module of claim 17, wherein each of the microcapsules or microcups comprises at least a positively-charged white particle or at least a negatively-charged black particle.

19. The touch display module of claim 13, wherein the first sensing layer and the second sensing layer include one or more materials selected from the group consisting of polyvinyl chloride, polyethylene terephthalate, polyimide, polyetheretherketone, polyethylene naphthalene-2, and 6-dicarboxylate.

20. The touch display module of claim 13, wherein the first sheet conducting layer and the second sheet conducting layer include one of more materials selected from the group consisting of gold, copper, carbon, silver, tin, and conductive polymer.

21. A touch display apparatus, comprising:
a controller; and
a touch display module of claim 1, the touch display module being electrically connected to the controller.

22. A touch display apparatus, comprising:
a controller; and
a touch display module of claim 13, the touch display module being electrically connected to the controller.
